(19) United States
(12) Patent Application Publication
(10) Pub. No.: US 2010/0329956 A1
(43) Pub. Date: Dec. 30, 2010

(54) Exhaust gas treatment method and system

(75) Inventor: Takayoshi Sawayama, Miyazaki (JP)

Correspondence Address: RABIN & Berdo, PC, 1101 14TH STREET, NW, SUITE 500, WASHINGTON, DC, 20005, US

(73) Assignee: OKI SEMICONDUCTOR CO., LTD., Tokyo (JP)

(21) Appl. No.: 12/801,288

(22) Filed: Jun. 2, 2010

(30) Foreign Application Priority Data
Jun. 29, 2009 (JP) 2009-153860

(51) Int. Cl. B01D 53/68; B01D 53/74

(52) U.S. Cl. 423/240 R; 422/169

(57) ABSTRACT

An exhaust gas treatment system treats exhaust gases collected from at least one PFC dealing device that deals with a PFC gas. The exhaust gas treatment system includes: an exhaust emission line through which the exhaust gases collected from the PFC dealing device; an external exhaust gas disposal device connected to the exhaust emission line so as to purify the exhaust gases for exhaust emission; a gas treatment device for eliminating the PFC gas from the exhaust gases; a gas treatment line branched from the exhaust emission line to supply the exhaust gases to the gas treatment device; and an intermediate line for discharge the treated exhaust gases from the gas treatment device to the external exhaust gas disposal device.

### BACKGROUND OF THE INVENTION

1. Field of the Invention

The present invention relates to a gas treatment method and gas treatment system such as gas recovery etc. used in semiconductor manufacturing processes, which performs treatment for an exhaust gas expelled from a PFC gas dealing device in which a PFC gas is used such as an etching device and the like in an etching treatment step which are used in semiconductor manufacturing semiconductor manufacturing equipment.

2. Description of the Related Art

Some gases such as fluorine compounds and the like used in an etching step and the like in the semiconductor manufacturing processes is influencing on Greenhouse effect, and such gases hardly decompose for a long time and stable for an extremely long time and they have a very higher global warming effect than that of carbon dioxide. There are CF₄, C₂F₆, C₃F₈, C₂F₄, CHF₃, C₄F₈, NF₃ and the like as Greenhouse effect gases. Generally, they are so-called as PFC (Per Fluoro Compound) gases having extremely high global warming coefficients. The PFC gases are used in the semiconductor manufacturing processes at a much smaller mass level in comparison with the usage of CO₂, but there is anxiety about accumulation of PFC emission in the air.

Greenhouse effect gases (e.g., PFC gases) are emitted together with exhaust gas in the air though not only the conventional etching step but also processing steps such as CVD (chemical vapor deposition) and the like in the manufacturing processes for semiconductor devices, liquid crystal devices and the like. Thus there is a problem of promotion of global warming.

Therefore there have been considered how to cope with reduction of the PFC gases in the semiconductor manufacturing processes. For example, there are some attempts: to optimize those processes to reduce the usage mass of PFC gases with a improved treatment method; to recover and reuse the PFC gases; to develop a treatment method to use an alternative gas; to develop another treatment method to decompose and detoxify the gases; and to develop a PFC gases recovery device (See Japanese Patent Application Publication No. 2005-188717).

### SUMMARY OF THE INVENTION

Generally, as shown in FIG. 1, a conventional exhaust gas treatment system uses suction pumps for exhaust gas of post-etching 11 attached to etching devices respectively in semiconductor manufacturing equipment. The exhaust gases are expelled from the suction pumps 11 after etching to pass through the exhaust emission line 5 of exhaust emission system towards a gas recovery device, a dry or wet type detoxification device or the like, and they are treated by the external exhaust gas disposal device 4, after that, they are expelled to the outside.

However, with such conventional processing steps, there is a problem insufficient to prevent from emission of Greenhouse effect gases (i.e. , PFC gases) for promoting global warming in the air.

Therefore, the present invention has been made in view of the above problems, and it is an object of the present invention to provide an exhaust gas treatment system and method capable of easily and sufficiently preventing from the PFC gases expelled from not only the conventional etching step but also processing steps such as CVD and the like in the manufacturing processes for semiconductor devices, liquid crystal devices and the like, using a pertinent device or recovery device and the like placed at the upstream near the PFC gas dealing device.

According to the present invention, there is provided an exhaust gas treatment system for treating exhaust gases collected from at least one PFC dealing device which deals with a PFC gas, the system comprising:

an exhaust emission line through which the exhaust gases collected from the PFC dealing device;

an external exhaust gas disposal device connected to the exhaust emission line so as to purify the exhaust gases for exhaust emission;

a gas treatment device for eliminating the PFC gas from the exhaust gases;

a gas treatment line branched from the exhaust emission line to supply the exhaust gases to the gas treatment device; and

an intermediate line for discharge the treated exhaust gases from the gas treatment device to the external exhaust gas disposal device.

Also, according to the present invention, there is provided an exhaust gas treatment method for treating exhaust gases collected from at least one PFC dealing device which deals with a PFC gas in an exhaust gas treatment system including an exhaust emission line through which the exhaust gases collected, an external exhaust gas disposal device purifying the exhaust gases for exhaust emission, a gas treatment device eliminating the PFC gas, a gas treatment line branched from the exhaust emission line and connected to the gas treatment device, and an intermediate line connected between the gas treatment device and the external exhaust gas disposal device, the method comprising the steps of:

switching from the exhaust emission line to the gas treatment line to supply the exhaust gases to the gas treatment device;

making the gas treatment device eliminate the PFC gas from the exhaust gases; and proceed

discharging the treated exhaust gases from the gas treatment device through the intermediate line to the external exhaust gas disposal device.

The exhaust gas treatment method and the exhaust gas treatment system according to the present invention are capable of recovering Greenhouse effect gases e.g., PFC gases and the like with the gas treatment device e.g., the gas recovery device via the gas treatment line, although those gases have been conventionally expelled as exhaust gas and the like to the outside. Namely, the present invention enables to provide a counter measures for global warming concerning the exhaust gas expelled from not only the conventional etching step but also processing steps such as CVD and the like in the manufacturing processes for semiconductor devices, liquid crystal devices and the like.

In addition, the exhaust gas treatment system mentioned above may further comprise a by-pass line connected between the gas treatment line and the intermediate line to detour around the gas treatment device, whereby prevention from stoppage of line (to stop operation of the semiconductor manufacturing equipment and the like) is achieved because of exhaust emission to the external exhaust gas disposal device even though the gas treatment device is stopped for some reason.

### BRIEF EXPLANATION OF THE DRAWINGS

The aforementioned aspects and other features of the invention are explained in the following description, taken in connection with the accompanying drawing figures wherein:

FIG. 1 is a schematic diagram showing an example of a conventional treatment system for treating the exhaust gases of post-etching;

FIG. 2 is a schematic diagram showing a exhaust gas treatment system of an embodiment according to the present invention; and

FIG. 3 is a schematic diagram showing an exhaust gas treatment system of another embodiment according to the present invention.

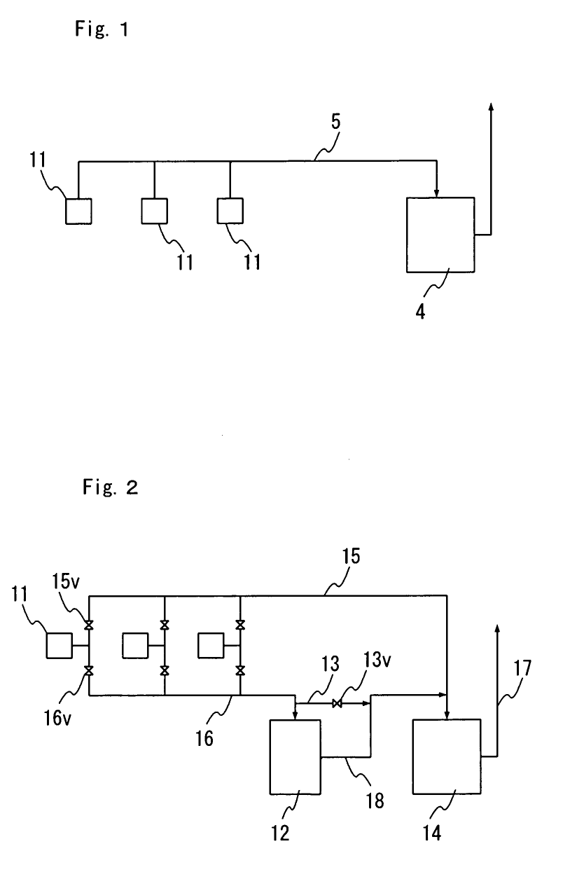

### DETAILED DESCRIPTION OF THE PREFERRED EMBODIMENT

Exemplary embodiments according to the present invention will be described in detail below with reference to the accompanying drawings.

There is described an exhaust gas treatment method and system as an example of the present embodiment in which the PFC gas is recovered from the exhaust gases of post-etching expelled from the etching device with the exhaust gas suction pump in the semiconductor manufacturing processes.

FIG. 2 is a schematic diagram showing the exhaust gas treatment system of such embodiment according to the present invention.

As shown in FIG. 2, suction pumps for exhaust gas of post-etching 11, attached to etching devices respectively in semiconductor manufacturing equipment (not shown), are connected via exhaust emission line valves 15v of open/close valve respectively to an exhaust emission line 15 connected to an external exhaust gas disposal device 14 in an exhaust emission system, in which each etching device is a PFC gas dealing device. The external exhaust gas disposal device 14 is provided with an external exhaust emission line 17 in order to pump out cleaned gases to the outside.

Further, the suction pumps for exhaust gas of post-etching 11 are connected via gas collecting line valves 16v of open/close valve respectively to a gas collecting line 16 (i.e., gas treatment line branched from the exhaust emission line) which is connected to a gas recovery device 12. The gas recovery device 12 is provided with an intermediate line 18 from which residue gases processed, in which PFC gas is extracted from the exhaust gases, are expelled to the exhaust emission line 15. The gas collecting line 16 at the inlet side of the gas recovery device 12 is connected to the intermediate line 18 at the outlet side of the gas recovery device 12 via a by-pass line valve 13v and a by-pass line 13.

When every gas collecting line valve 16v is closed and every exhaust emission line valve 15v is opened, the exhaust gases pumped out from the suction pumps for exhaust gas of post-etching 11 attached to the etching device join and flow through the exhaust emission line 15 to the external exhaust gas disposal device 14, and are processed therein and released from the external exhaust emission line 17 to the outside of the factory. The gas collecting line valve 16v and the exhaust emission line valve 15v function as switching valves to switch the exhaust gases of post-etching to the exhaust emission line 15 and/or the gas collecting line 16.

When every gas collecting line valve 16v is opened and every exhaust emission line valve 15v is closed, the exhaust gases flow in the gas collecting line 16 to the gas recovery device 12 in which a predetermined gas recovery treatment is carried out, then the treated gases are pumped out via the intermediate line 18 and the exhaust emission line 15 to the external exhaust gas disposal device 14, and the treated cleaned gases are processed therein and released from the external exhaust emission line 17 to the outside of the factory. Further, normally the by-pass line valve 13v is closed.

In the present embodiment, the switching valves switch the exhaust gases pumped out from the suction pump for exhaust gas of post-etching 11 to the gas collecting line 16, and then the gas recovery device 12 extracts PFC gas from the exhaust gases to recovery the PFC gas. In addition, in case that an emergency situation and the like need to detour the gas recovery device 12, the gas recovery device 12 may be detoured by opening the by-pass line valve 13v of the by-pass line 13.

Thus, in the exhaust gas treatment method of the present embodiment, the exhaust gases of post-etching are processed from the etching device through the exhaust emission line and the external exhaust gas disposal device 14 to clean the gases for exhaust emission, by using the exhaust gas treatment system, in which the exhaust gases of post-etching pumped from the etching device are switched from the exhaust emission line to the gas collecting line, and then the gas recovery device 12 connected to the gas collecting line carries out a step of eliminating the PFC gas from the exhaust gases of post-etching, and then a step of discharging the treated exhaust gases from the gas recovery device 12 (i.e., gas treatment device) through the intermediate line 18 to the external exhaust gas disposal device 14.

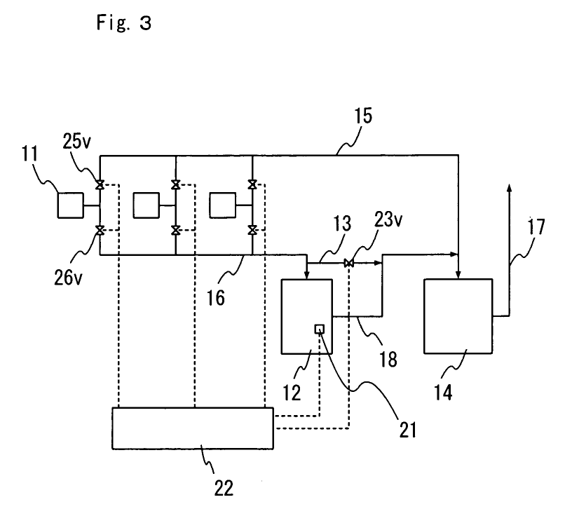

As shown in FIG. 3, in another embodiment according to the present invention, suction pumps for exhaust gas of post-etching 11, attached to etching devices of PFC gas dealing device respectively in semiconductor manufacturing equipment, are connected via electric motor operated valves 25v of open/close valve respectively to an exhaust emission line 15 connected to an external exhaust gas disposal device 14 in an exhaust emission system, in which each electric motor operated valve 25v of the exhaust emission line is driven by an electrically controlled actuator. The external exhaust gas disposal device 14 is provided with an external exhaust emission line 17 in order to pump out cleaned gases to the outside.

Further, the suction pumps for exhaust gas of post-etching 11 are connected via electric motor operated valves 26v of open/close valve respectively to a gas collecting line 16 which is connected to a gas recovery device 12, in which each electric motor operated valve 26v of the gas collecting line is driven by an electrically controlled actuator. The gas recovery device 12 is provided with an intermediate line 18 from which residue gases processed, in which PFC gas is extracted from the exhaust gases, are expelled to the exhaust emission line 15. The gas collecting line 16 at the inlet side of the gas recovery device 12 is connected to the intermediate line 18 at the outlet side of the gas recovery device 12 via an electric motor operated by-pass line valve 23v and a by-pass line 13, in which the electric motor operated by-pass line valve 23v of the by-pass line is driven by an electrically controlled actuator.

Furthermore, the gas recovery device 12 is provided with a sensor 21 which detects temperature, pressure etc. within the device to output a situational signal of the gas recovery device.

This system includes a control unit 22 connected via control lines, in broken lines shown in FIG. 3, to the electric motor operated valve of the exhaust emission line 25v, the electric motor operated valve of the gas collecting line 26v, and the electric motor operated valve of the by-pass line valve 23v which are electrically controlled by the actuator subject to the control unit 22 receiving the output of the sensor 21 to monitor the condition of the gas recovery device 12. The control unit 22 may be composed of a computer such as a PC and the like capable of automatic controlling and/or remote controlling the devices.

When every electric motor operated valve 26v of the gas collecting line is closed and every electric motor operated valve 25v of the exhaust emission line is opened by signals from the control unit 22, the exhaust gases pumped out from the suction pumps for exhaust gas of post-etching 11 attached to the etching device join and flow through the exhaust emission line 15 to the external exhaust gas disposal device 14, and are processed therein and released from the external exhaust emission line 17 to the outside of the factory.

When every electric motor operated valve 26v of the gas collecting line is opened and every electric motor operated valve 25v of the exhaust emission line is closed by signals from the control unit 22, the exhaust gases flow in the gas collecting line 16 to the gas recovery device 12 in which a predetermined gas recovery treatment is carried out, then the treated gases are pumped out via the intermediate line 18 and the exhaust emission line 15 to the external exhaust gas disposal device 14, and the treated cleaned gases are processed therein and released from the external exhaust emission line 17 to the outside of the factory. Further, normally the electric motor operated by-pass line valve 23v of the by-pass line is closed.

Thus, due to the signals from the control unit 22, the switching valves 25v, 26v switch the exhaust gases pumped out from the suction pump for exhaust gas of post-etching 11 to the gas collecting line 16, and then the gas recovery device 12 extracts PFC gas from the exhaust gases to recovery the PFC gas.

When, due to the output signals from the sensor 21, the control unit 22 detects an emergency situation and the like of the gas recovery device 12, the control unit makes the electric motor operated by-pass line valve 23v of the by-pass line 13 open to detour the gas recovery device 12.

The position and number of the sensor 21 on the gas recovery device 12 is not particularly limited, the sensor 21 may be placed on the external exhaust gas disposal device 14, the suction pump for exhaust gas of post-etching 11, the main body of the etching device and the like. Further, the sort of the sensor is not particularly limited. Using the output signals from those sensors, the control unit 22 may be constituted so as to control not only the electric motor operated valve of the by-pass line valve 23v but also the electric motor operated valve of the exhaust emission line 25v and the electric motor operated valve of the gas collecting line 26v.

Although the gas recovery device has been described as a gas treatment device in the embodiment mentioned above, such gas recovery device is not limited in the present invention. Instead of the gas recovery device of the gas collecting line branched form the exhaust emission line, a PFC gases detoxification device (e.g., Combustion-type detoxification device, plasma-type detoxification device or the like) may be usable in the present invention for the gas treatment system of the gas treatment line branched form the exhaust emission line similarly to the above embodiment. The present invention is adaptable to not only the conventional etching step but also processing steps such as CVD and the like in the manufacturing processes for semiconductor devices, liquid crystal devices and the like.

As mentioned above, according to the present invention, the gas treatment device scheme has the gas collecting line and the gas recovery device and the like in which the exhaust emission line and the gas collecting line are provided with the switching valves whereby the exhaust gas treatment suitable for counter measures for global warming is achieved and further, it may be adapted to the sensor and feedback system and the like using automatic control, remote control, detection of pressure and/or temperature and the like.

It is understood that the foregoing description and accompanying drawings set forth the preferred embodiments of the invention at the present time. Various modifications, additions and alternative designs will, of course, become apparent to those skilled in the art in light of the foregoing teachings without departing from the spirit and scope of the disclosed invention. Thus, it should be appreciated that the invention is not limited to the disclosed embodiments but may be practiced within the full scope of the appended claims.

This application is based upon and claims the benefit of priority from the prior Japanese Patent Application No. 2009-153860, filed Jun. 29, 2009, the entire contents of which are incorporated herein by reference.

What is claimed is:

1. An exhaust gas treatment system for treating exhaust gases collected from at least one PFC dealing device which deals with a PFC gas, the system comprising:
an exhaust emission line through which the exhaust gases collected from the PFC dealing device;
an external exhaust gas disposal device connected to the exhaust emission line so as to purify the exhaust gases for exhaust emission;
a gas treatment device for eliminating the PFC gas from the exhaust gases;
a gas treatment line branched from said exhaust emission line to supply the exhaust gases to the gas treatment device; and
an intermediate line for discharge the treated exhaust gases from said gas treatment device to said external exhaust gas disposal device.

2. The exhaust gas treatment system according to claim 1, further comprising a by-pass line connected between said gas treatment line and said intermediate line to detour around said gas treatment device.

3. The exhaust gas treatment system according to claim 1, wherein said gas treatment device includes a gas recovery device.

4. An exhaust gas treatment method for treating exhaust gases collected from at least one PFC dealing device which deals with a PFC gas in an exhaust gas treatment system including an exhaust emission line through which the exhaust gases collected, an external exhaust gas disposal device purifying the exhaust gases for exhaust emission, a gas treatment device eliminating the PFC gas, a gas treatment line branched from said exhaust emission line and connected to the gas treatment device, and an intermediate line connected between the gas treatment device and said external exhaust gas disposal device, the method comprising the steps of:
switching from said exhaust emission line to the gas treatment line to supply the exhaust gases to the gas treatment device;
making the gas treatment device eliminate the PFC gas from the exhaust gases; and
discharging the treated exhaust gases from said gas treatment device through the intermediate line to said external exhaust gas disposal device.

5. The exhaust gas treatment method according to claim 4, wherein said PFC dealing device includes an etching device.
